(19) United States
(12) Patent Application Publication
(10) Pub. No.: US 2005/0206050 A1
(43) Pub. Date: Sep. 22, 2005

(54) Method of manufacturing ceramic body and firing jig

(75) Inventors: Kunihiko Yoshioka, Nagoya-City (JP); Fumitake Takahashi, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/031,954

(22) Filed: Jan. 7, 2005

(30) Foreign Application Priority Data
Jan. 13, 2004 (JP) 2004-005592
Dec. 27, 2004 (JP) 2004-376473

(51) Int. Cl. C04B 33/32

(52) U.S. Cl. 264/667

(57) ABSTRACT

There are disclosed a manufacturing method and a firing jig capable of obtaining a ceramic body having a diaphragm structure having lower deflection of a thin portion. There is provided a method of manufacturing a ceramic body comprising a step of firing a formed body having a diaphragm structure including a thick portion and a plate-like thin portion disposed in such a manner that a concave portion or a hollow portion is formed by the thin and thick portions. In the method, firing is started in a state in which a thermal buffer is disposed in a position covering the thin portion in a contact or non-contact state with respect to the thin portion. There is provided a firing jig comprising: a thermal buffer portion formed of porous ceramic; a spacer disposed on one surface of the thermal buffer portion; and a weight adjusting portion disposed in non-contact with respect to the thermal buffer portion via the spacer. A space is formed between the thermal buffer portion and the weight adjusting portion.

### BACKGROUND OF THE INVENTION AND THE RELATED ART

The present invention relates to a method of manufacturing a ceramic body, and a jig for firing a ceramic body, more particularly to a manufacturing method preferable for ceramic body comprising a so-called diaphragm structure, and a ceramic body firing jig.

In various types of electronic components, a substrate formed of ceramic has been broadly applied, and as a typical substrate, there has been a substrate having a diaphragm structure applied to a piezoelectric/electrostrictive film type element or the like.

The substrate having the diaphragm structure is a substrate having a structure in which a plate-like thin portion is supported between thick portions and which has a concave portion or a hollow portion below or above the thin portion, and this thin portion functions as a vibrating portion in the piezoelectric/electrostrictive film type element.

Additionally, in recent years, the substrate formed of ceramic applied to various electronic components have been required to be thinner, smaller, and more complicated. On the other hand, deformation at a firing time has raised a problem, and various attempts have been made to prevent the deformation at the firing time.

For example, in Patent Document 1, a method has been described in which a ceramic body warped or deformed otherwise by the firing is subjected to a heating process at high temperature again while a weight is placed on an upper part of the body to thereby reform/correct the deformation including the warp (see, e.g., Patent Document 1: JP-2000-169265A).

However, since the manufacturing method described in Patent Document 1 requires two heating processes, energy consumption is very large, and a large problem has been raised in reducing product costs. Since the once deformed body is corrected, not a little stress remains in a reformed substrate. Additionally, since a reforming step is performed by re-heating, grain growth of a ceramic material and phase transformation occur. Therefore, the reformed substrate of ceramic has not been sufficient also in strength or moisture resistance. Furthermore, the thin portion is sometimes broken depending on application of weighting by a weight plate.

On the other hand, a method has been proposed in which a fired plate superior in surface smoothness and having a thickness of 0.5 mm or less is formed using a weight whose weight, area, and weighting per unit area satisfy a predetermined relation in order to prevent the warp of a ceramic green sheet at a firing time. Also from a viewpoint of degreasing, a weight having a porosity of 5 to 30% has been described (see, e.g., Patent Document 2: JP-06-9268A).

Moreover, as a method of reducing warp and undulation in firing to form a fired plate having an area of 400 cm² or more and a thickness of 0.4 mm or less, a method has been described in which the green sheet is held between porous alumina sheets, and the weight is applied to several layers of the sheets (see, e.g., Patent Document 3: JP-2830795B).

However, in the methods described in JP-06-9268A and JP-2830795B, application to the ceramic body having a diaphragm structure has not been considered, and any solving method has not been described with respect to the deformation of the thin portion having the diaphragm structure.

Moreover, with regard to the ceramic body comprising the diaphragm structure, even with a size which is not a target of the method described in Patent Document 2 or 3, the warp and undulation are generated because of a complicated shape. Furthermore, in a reheating method while applying the weight by the weight plate, the deformation of the thin portion which has been deformed by inward deflection cannot be corrected. Additionally, to correct the warp and undulation of the ceramic body having the thin portions formed on opposite surfaces thereof, the deflection of the thin portion on an upward curved side of the deformation is compressed, and the portion is further deflected. Therefore, a difference of a deflected amount between the opposite surfaces increases. Therefore, the curved thin portion has been applied to various elements as such in the present situation.

### SUMMARY OF THE INVENTION

The present invention has been developed to address the above-described problems, and aims at providing a method of manufacturing a ceramic body comprising a diaphragm structure and having a desired shape with lower deformation of a thin portion, and a firing jig for use in the method.

The present inventor has intensively studied the above-described problems in order to address them, and has found that deflection or deformation of the thin portion in the diaphragm structure occurs as follows. When a formed body comprising the diaphragm structure is fired, even after the thin portion is sintered to form the ceramic body, sintering of a thick portion proceeds, and the thick portion continues to shrink. Therefore, when the thick portion shrinks by firing, the thin portion already has large rigidity, and cannot follow shrinkage of the thick portion. Therefore, the thin portion is deflected to a hollow portion side or an opposite side by the shrinkage of the thick portion, and this has been a main cause for the deformation of the ceramic body comprising the diaphragm structure.

Furthermore, by firing a formed body having the diaphragm structure in a state that a thermal buffer is disposed in a position covering the thin portion in contact with the thin portion, or in a non-contact state in which the buffer is disposed close to the thin portion, a difference of a sintering time between the thin portion and the thick portion is reduced, the whole formed body is sintered substantially at the same timing, and the deflection of the thin portion decreases. This has been found, and the present invention has been completed. Here, the sintering time means a time required from when the sintering of each portion starts until the sintering completes.

That is, according to the present invention, there is provided a method of manufacturing a ceramic body comprising a step of firing a formed body having a diaphragm structure including a thick portion and thin portion disposed in such a manner that a concave portion or a hollow portion is formed by the thin and thick portions, wherein the firing is started in a state in which a thermal buffer is disposed in a position covering the thin portion in a contact or non-contact state with respect to the thin portion of the formed body.

In the present invention, it is preferable that the firing is started in a state in which at least two buffers having a flat plate shape are disposed as the thermal buffers in positions facing each other across the formed body.

Moreover, in the present invention, it is preferable that the formed body has the diaphragm structure comprising the two thin portions disposed facing each other across the hollow portion, and the firing is started in a state in which the thermal buffers are disposed in positions covering two thin portions.

Here, in the present specification, the “thermal buffer” means a buffer which reduces a difference of a heat amount received in an arbitrary unit volume for an arbitrary unit time between the thin and thick portions in firing as compared with that in the firing in a state in which the thin and thick portions are open to the atmosphere.

Additionally, in the present invention, the thermal buffer having a heat capacity per unit area of equal to or higher than that of the thin portion covered with the thermal buffer is preferably used.

Moreover, a relation of a heat capacity difference (Cₛ) per unit area between the thin and thick portions with respect to a heat capacity (C_{b}) per unit area of the thermal buffer preferably satisfies the following formula.
0≦((C_{b}−Cₛ)/Cₛ)×100≦300 1,
where (Cₛ) and (C_{b}) indicate values obtained by the following equations:
C_{b}=(ρ_{b}×d_{b}×t_{b}) 2,
where C_{b}: heat capacity per unit area of the thermal buffer, ρ_{b}: specific heat of the thermal buffer, t_{b}: thickness of the thermal buffer, and d_{b}: density of the thermal buffer; and
Cₛ=(ρₛ×dₛ×(t₂−t₁)) 3,
where Cₛ: heat capacity of unit area of the thin portion, ρₛ: specific heat of the formed body, t₁: thickness of the thin portion of the formed body, t₂: thickness of the thick portion of the formed body (additionally, t₂ denotes a half of the total thickness in a case where the formed body has two thin portions facing each other across the hollow portion), and dₛ: density of the formed body.

Moreover, in the present invention, an interval between the thin portion and the thermal buffer is preferably not more than the thickness of the thermal buffer. Further preferably, this interval is not more than a difference of the thickness between the thick and thin portions. It is to be noted that in the present invention, the formed body having a convex portion formed on the surface thereof or the thermal buffer having a convex portion formed on the surface thereof may be used to dispose the thermal buffer in such a manner as to bring the convex portion into contact with the thermal buffer or the formed body so that at least a part of the thin portion is brought into a non-contact state with respect to the thermal buffer. In this case, a method for forming the convex portion is not especially limited as long as a thin film is formed. From a viewpoint of mass productivity, a screen printing process is preferable.

In the present invention, the thermal buffer is preferably a porous body having a porosity of 1 to 70%.

Moreover, the firing is preferably performed in a state in which the thermal buffer pressurizes the formed body. It is also preferable that the formed body is disposed in such a manner that the upper surface of the thin portion is substantially horizontal, and the thermal buffer is disposed on an upper surface of the thin portion.

As described above, the thermal buffer may also have a function of a weight member. In this case, the firing is further preferably started in a state in which a spacer is disposed on the thermal buffer, and a weight adjusting member is disposed above the thermal buffer via the spacer. In this case, the spacer is further preferably positioned above the formed body or a ceramic body formed by firing the formed body from start of the firing till the end of the firing.

A pressurizing force for pressurizing the formed body in this manner is preferably a weight per unit volume in a range of 1×10⁻⁴ to 2×10⁻¹ g/mm³. A thermal buffer having a thickness of 0.3 to 10.0 mm is usable.

Moreover, an arithmetic average roughness (Ra) per unit contact area of a face of the thermal buffer brought into contact with the formed body is preferably 0.1≦Ra75≦10.0 μm, and thermal conductivity of the thermal buffer is preferably larger than that of the thin portion. The formed body of the present invention may have one concave portion or hollow portion, or two or more concave portions or hollow portions.

Furthermore, according to the present invention, there is provided a firing jig suitable for the manufacturing method, that is, a firing jig comprising: a thermal buffer portion formed of porous ceramic; a spacer disposed on one surface of the thermal buffer portion; and a weight adjusting portion disposed in non-contact with respect to the thermal buffer portion via the spacer, wherein a space is formed between the thermal buffer portion and the weight adjusting portion.

In the firing jig of the present invention, the thermal buffer portion is preferably a porous body having a porosity of 1 to 70% and preferably has a thickness of 0.3 to 10.0 mm.

Moreover, an arithmetic average roughness (Ra75) of at least a part of an outer surface of the thermal buffer portion, that is, per unit contact area of the surface contacting the body to be fired is preferably 0.1≦Ra75≦10.0 μm. Here, Ra75 is a value which can be obtained by a method according to JIS'82 using SURFCOM480A manufactured by Tokyo Seimitsu Co., Ltd. as a measurement device on conditions that a probe is diamond having a tip radius of 5 μm and a tip angle of 60°, a measurement speed is 0.6 mm/sec, a cutoff is 0.8 mm, and a measurement distance is 5 mm.

According to the present invention, in the ceramic body comprising the diaphragm structure, there can be provided a manufacturing method capable of obtaining a ceramic body having a desired shape with lower deflection. There can be also provided a firing jig which applies an appropriate weight to a body to be fired when firing to form the ceramic body having various shapes including the diaphragm structure and which is superior in outgassing at a firing time and by which little breakage or deformation occurs in the obtained ceramic body.

### BRIEF DESCRIPTION OF THE DRAWINGS

FIG. 1 is a schematic sectional view showing one example of arrangement of a thermal buffer in a manufacturing method of the present invention;

FIG. 2 is an explanatory view schematically showing behavior concerning firing shrinkage occurred in a formed body in a firing step according to one embodiment of the manufacturing method of the present invention;

FIG. 3 is an explanatory view schematically showing behavior concerning firing shrinkage occurred in the formed body in the firing step according to another embodiment of the manufacturing method of the present invention;

FIG. 4 is an explanatory view showing another example of arrangement of the thermal buffer in the manufacturing method of the present invention;

FIGS. 5(a) and 5(b) are explanatory views showing one example of a firing jig of the present invention, and a state in which the jig is used and disposed to the formed body, FIG. 5(a) is a schematic plan view, and FIG. 5(b) is a schematic sectional view;

FIG. 6 is an explanatory view schematically showing a manufacturing method of the present invention;

FIG. 7 is a side view schematically showing one example of an intermediately prepared formed body in the manufacturing method of the present invention;

FIG. 8 is an explanatory view schematically showing one example of a step of preparing the formed body according to one embodiment of the manufacturing method of the present invention;

FIG. 9 is an explanatory view schematically showing the behavior concerning the firing shrinkage occurred in the formed body in a firing step of a conventional manufacturing method; and

FIG. 10 is a plan view schematically showing a sample prepared in the embodiment.

### DESCRIPTION OF REFERENCE NUMERAL

1 thick portion; 2 (2a, 2b, 2c, 2d) thin portion; 3 formed body; 4 (4a, 4b) thermal buffer; 6 concave portion; 7 communication hole; 8 hollow portion; 10 ceramic body; 11 laminated body; 15, 16 green sheets; 17 slit; 18 through hole; 21 spacer; 22 weight adjusting member; 23 space; 25 firing jig.

### DESCRIPTION OF THE PREFERRED EMBODIMENT

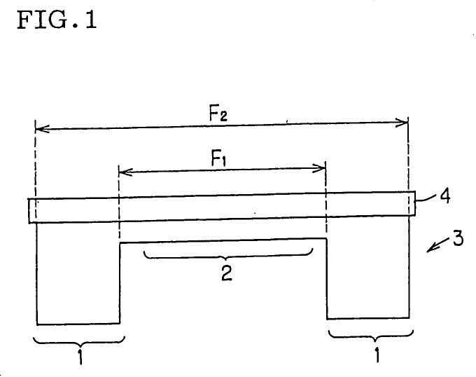

An embodiment of the present invention will be described hereinafter concretely. However, the present invention is not limited to the following description, and can be variously changed, modified, or improved based on knowledge of a person skilled in the art without departing from the spirit of the present invention. FIG. 1 is a sectional view schematically showing one embodiment of the present invention.

As shown in FIG. 1, a method of manufacturing a ceramic body of the present invention includes a step of firing a formed body 3 comprising a diaphragm structure having a thick portion 1 and a plate-like thin portion 2 in which the thick portion(s) 1 and the thin portion 2 are arranged in such a manner that a concave portion or a hollow portion is formed by the thin portion 2 and the thick portion(s) 1. A thermal buffer 4 is disposed in a position covering preferably the whole surface of the thin portion, further preferably the whole surface constituted by the thin and thick portions in a state in which the thermal buffer 4 is brought into contact with the surface, and the firing is performed. Alternatively, the thermal buffer 4 is disposed in the position covering the whole surface of the thin portion 2, preferably the whole surface constituted by the thin and thick portions in a non-contact state with respect to a part or all of the thin portion 2, and the firing is performed. It is to be noted that FIG. 1 shows two thick portions 1 and the thin portion 2 disposed between the thick portions. The thick portions 1 may be independent, or two thick portions 1 shown in FIG. 1 may be formed, for example, into an annular shape and connected to each other.

Accordingly, a ceramic body having a desired diaphragm structure in which deflection of the thin portion 2 is suppressed. Since the deflection of the thin portion is suppressed, the ceramic body has, for example, a sandwich structure (a structure described, e.g., in JP-2001-320099A) as in an HDD element, and is applicable as a component requiring high precision, and a desired performance can be exerted. Here, description of JP-2001-320099A is included in the description of the present specification.

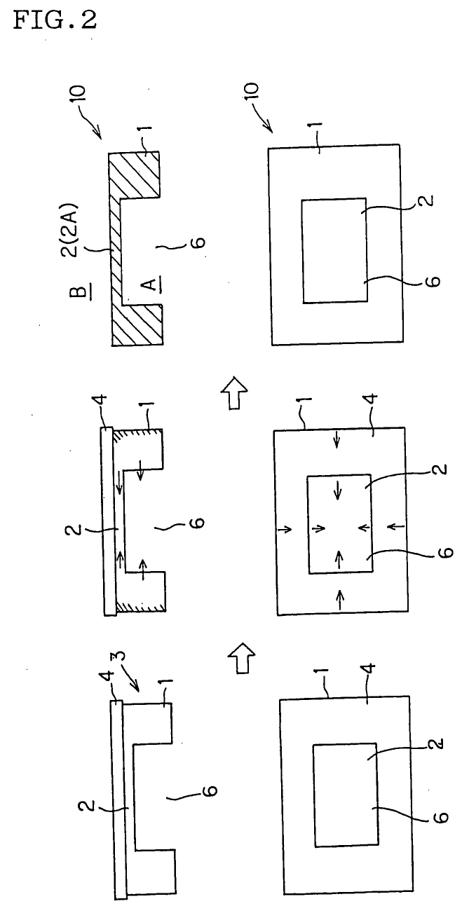

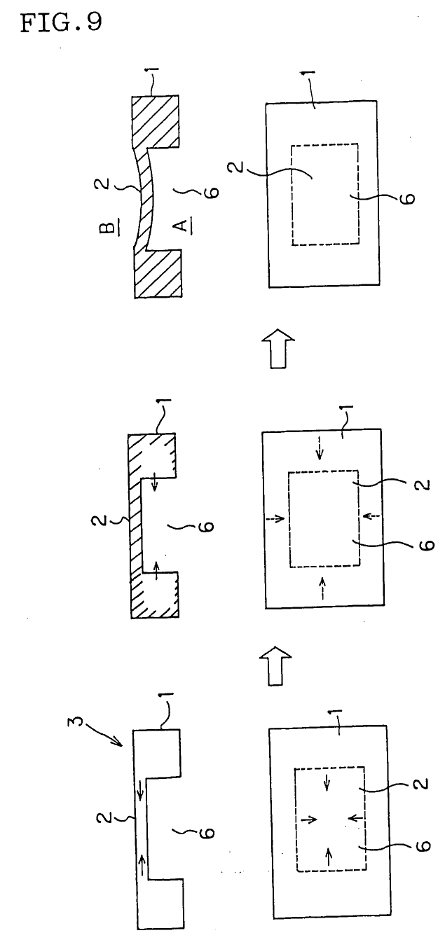

Here, a basic principle of the manufacturing method of the present invention will be described with reference to the drawings. FIG. 9 is an explanatory view of behavior of a formed body in a case where the formed body is fired in a state in which the thin portion is directly open to the atmosphere. The formed body has a diaphragm structure in which one plate-like thin portion 2 is supported between the thick portions 1, and a concave portion 6 is formed under the thin portion 2. FIG. 2 is an explanatory view showing behavior of the formed body in a case where the formed body having the same diaphragm structure is fired while a buffer is brought into contact with the thin portion (manufacturing method of the present invention).

It is to be noted that arrows in each figure show a state in which major firing shrinkage is in progress in the thin and thick portions. A region shown by slanted lines is a ceramic portion which has been substantially sintered.

As shown in FIG. 9, in a case where the formed body 3 having the diaphragm structure including the thin portion 2 and thick portion 1 is fired in a state in which both the thin portion 2 and the thick portion 1 are open to atmosphere, the sintering of the thin portion 2 first completes because of a thickness difference. Moreover, even after the sintering of the thin portion 2 substantially ends and most of the thin portion is formed into ceramic, the thick portion 1 is still being sintered. Therefore, a stress by the shrinkage of the thick portion 1 is applied to the thin portion 2 (shown by slanted lines) already having high rigidity, and the sintering is finished in a state in which the thin portion is deflected to a hollow portion side A or an opposite side B.

On the other hand, as shown in FIG. 2, when the formed body 3 having the same diaphragm structure is fired while the thermal buffer 4 is brought into contact with the thin portion 2, heat of a firing atmosphere is transferred to the thin portion 2 and the thick portion 1 via the thermal buffer 4, and an amount of the heat transferred to the thin portion 2 and thick portion 1 per unit time is small as compared with direct transferring from the atmosphere. Therefore, when the heat capacity of the thermal buffer 4 is adjusted, progress of the sintering of the thin portion 2 can be brought close to that of the sintering of the thick portion 1. Furthermore, local unevenness of the transferring heat amount is suppressed by the presence of the thermal buffer 4, and the ceramic body having the diaphragm structure in which the deflection of the thin portion 2 is suppressed can be obtained.

It is to be noted that this effect can be obtained, even when the thermal buffer 4 is not brought into direct contact with the thin portion 2. This is because thermal energy is transferred to the thin portion 2 from the thermal buffer 4 by radiation, although the thin portion 2 is not brought into contact with the thermal buffer 4. That is, even when the thermal buffer 4 is disposed in such a manner that the thermal buffer 4 covers the thin portion 2 in a non-contact state with respect to at least a part of the thin portion 2, the progress of the sintering of the thin portion 2 can be brought close to that of the sintering of the thick portion 1. However, when the interval is excessively broad, air flows between the thin portion 2 and the thermal buffer 4, the thermal energy is lost from the surface of the thin portion or the thermal buffer, and an effect of the present invention is not sufficiently exerted. Therefore, an interval between the thermal buffer 4 and the thin portion 2 is preferably in a range of 0 (i.e., a contact state) to an interval which is not more than the thickness of the thermal buffer, further preferably in a range of 0 to an interval which is not more than a half of the thickness of the thermal buffer. When the interval between the thermal buffer 4 and the thin portion 2 is larger than a thickness difference between the thick portion 1 and the thin portion 2, that is, the thickness of the concave portion 6, an influence of an object existing in a position facing the thin portion 2 via the concave portion 6 is sometimes greater than an effect of the thermal buffer 4. Therefore, the interval between the thermal buffer 4 and the thin portion 2 is preferably smaller than the thickness difference between the thick portion 1 and the thin portion 2.

As a concrete method of disposing the thermal buffer 4 in a position covering the thin portion 2 in a non-contact state with respect to the thin portion 2, for example, a convex portion is disposed on the surface of a part of the formed body 3, preferably on the surface of an outer peripheral portion, and the thermal buffer 4 is brought into contact with the convex portion and disposed in such a manner as to cover the thin portion 2. That is, a predetermined interval is formed between the thin portion 2 and the thermal buffer using the convex portion as a spacer. In this case, a height of the convex portion corresponds to this interval. As a preferably method in which the convex portion is disposed in such a manner that the interval between the thermal buffer 4 and the thin portion 2 falls in the above-described preferable range, for example, a thin film is formed as the convex portion on the formed body by printing such as screen printing. It is to be noted that even when the convex portion is disposed on the thermal buffer 4, a similar effect is obtained. When the convex portion is disposed in such a manner as to surround an outer peripheral portion of the surface of the formed body, a flow of air can be substantially interrupted, and the loss of the thermal energy can be preferably suppressed.

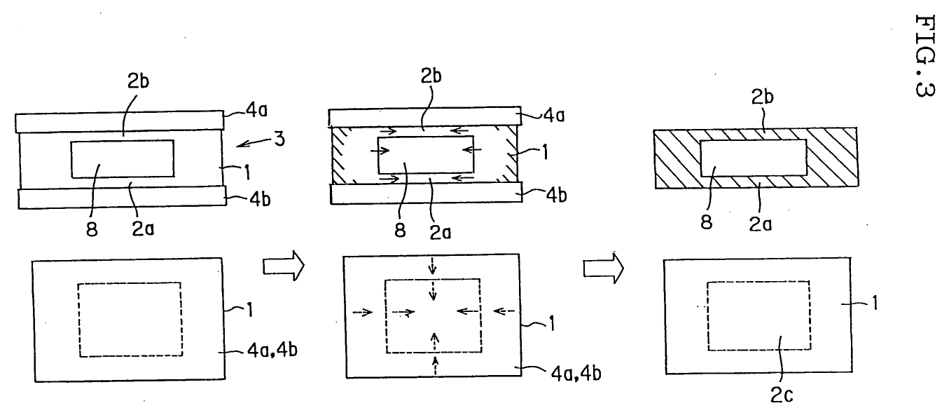

FIG. 3 is an explanatory view showing the behavior of the formed body. The formed body has a diaphragm structure comprising two thin portions 2a, 2b facing each other across a hollow portion 8, and the body is fired in a state in which buffers 4a, 4b are brought into contact with both the thin portions, or in a non-contact state in which the buffers are disposed in the very vicinity of the thin portions (hereinafter the “contact” also includes a partial contact and a non-contact state with close proximity as long as “direct contact” is not described.

In the present invention, as shown in FIG. 3, the firing is preferably started in a state in which the thermal buffer 4a, 4b are brought into contact with the respective thin portions 2a, 2b, respectively.

When the formed body has two thin portions 2a, 2b, as shown in FIG. 3, the thermal buffer 4a, 4b may be brought into contact with both the thin portions 2a, 2b, and the formed body 3 having the diaphragm structure is fired. By this arrangement, the heat amount transferred to the respective thin portions 2a, 2b from firing atmosphere such as outside air similarly becomes small. The progress of the sintering of the respective thin portions 2a, 2b can be brought close to that of the sintering of the thick portion 1. Moreover, the sintering can proceed substantially simultaneously between the thin portions 2a, 2b. The local unevenness of the transferring heat amount to the thin portions is inhibited. Therefore, the ceramic body having the diaphragm structure whose deflection is inhibited can be obtained in both of the thin portions 2a, 2b. Even in the embodiment shown in FIG. 3, when the interval between the thermal buffer 4a or 4b and the thin portion 2b or 2a is excessively large, the effect of the present invention is excessively small in some case. Therefore, this interval is preferably in a range of 0 (i.e., contact state) to an interval which is not more than the thickness of the thermal buffer 4a or 4b, further preferably in a range of 0 to an interval which is not more than the half of thickness of the thermal buffer 4a or 4b. Furthermore, when this interval is larger than a difference between the thickness of the thick portion 1 and total thickness of the thin portions 2a, 2b, that is, the height of the hollow portion 8, for example, an influence of the thin portion 2a facing across the hollow portion 8 or the thermal buffer 4b is larger than the effect of the thermal buffer 4a with respect to the thin portion 2b in some case. Therefore, the interval between the thermal buffer 4a or 4b and the thin portion 2b or 2a is preferably smaller than the difference between the thickness of the thick portion 1 and the total thickness of the thin portions 2a, 2b.

To effectively decrease a sintering completion time difference between the thin portion 2 and the thick portion 1, the thermal buffer 4 is preferably used having a heat capacity per unit area, which is equal to or larger than that of the thin portion 2 or the thick portion 1 which is to be contacted. A reason why the heat capacity is large is that energy density supplied to the surface of the thin portion brought into contact with the thermal buffer at an arbitrary time, especially at an initial firing time is reduced, and a temperature distribution can be narrowed.

Furthermore, a relation of the heat capacity difference (Cₛ) between the thin and thick portions per unit area, obtained by equation 3, with respect to a heat capacity (C_{b}) per unit area of the thermal buffer, obtained by equation 2, preferably satisfies the following formula.
0≦((C_{b}−Cₛ)/Cₛ)×100≦300 1
C_{b}=(ρ_{b}×d_{b}×t_{b}) 2,
where C_{b}: heat capacity per unit area of the thermal buffer, ρ_{b}: specific heat of the thermal buffer, t_{b}: thickness of the thermal buffer, and d_{b}: density of the thermal buffer; and
Cₛ=(ρₛ×dₛ×(t₂−t₁)) 3,
where Cₛ: heat capacity of unit area of the thin portion, ρₛ: specific heat of the formed body, t₁: thickness of the thin portion of the formed body, t₂: thickness of the thick portion of the formed body, and dₛ: density of the formed body.

Moreover, the thickness of the thermal buffer 4 in the present invention may be increased in order to increase the heat capacity per unit area, but the heat capacity may be adjusted by a material characteristic of the thermal buffer 4.

When the heat capacity is adjusted by the material characteristic, an excessive weight applied to the formed body can be a hollow portion. Therefore, frictional resistance between the formed body 3 and the thermal buffer 4 can be reduced, strain of dimensional precision generated during firing shrinkage of the formed body 3 can be suppressed. When the thermal buffer is porous as described later, degreasing is facilitated by reducing the thickness of the buffer.

Concretely, the thermal buffer formed of a material having specific heat larger than that of the material constituting the thin portion to be contacted with the buffer is preferably used, and the material may be appropriately selected from a relation with respect to the characteristic of the formed body based on the characteristics of the materials shown in Table 1. For example, when the materials constituting the thin and thick portions are zirconia, materials of alumina, spinel, magnesia, beryllia and the like are usable as the buffer. When the material constituting the thin portion is alumina, materials of magnesia, beryllia and the like are usable as the buffer.

TABLE 1

| | Specific | Specific | Thermal |
|---|---|---|---|
| | heat | gravity | conductivity |
| | (J/g K) | (g/cm³) | (W/m K) |
| Zirconia | 0.45 | 5.9 | 2.6 (at 1500° C.) |
| Alumina | 0.77 | 4.0 | 5.8 (at 1500° C.) |
| Spinel | 0.80 | 3.6 | 5.8 (at 1000° C.) |
| Magnesia | 0.94 | 3.6 | 6.3 (at 1500° C.) |
| Beryllia | 1.00 | 3.0 | 15.7 (at 1500° C.) |

Moreover, with regard to the thermal buffer 4 in the present invention, a thermal buffer having a thermal conductivity which is larger than that of the thin portion is preferable, and the thermal buffer 4 is further preferably formed of a material having a thermal conductivity of 2.0 (W/m K) or more in that the buffer is capable of further uniformly transferring heat to the thin portion 2.

Moreover, examples of the material include alumina, spinel, magnesia, beryllia and the like.

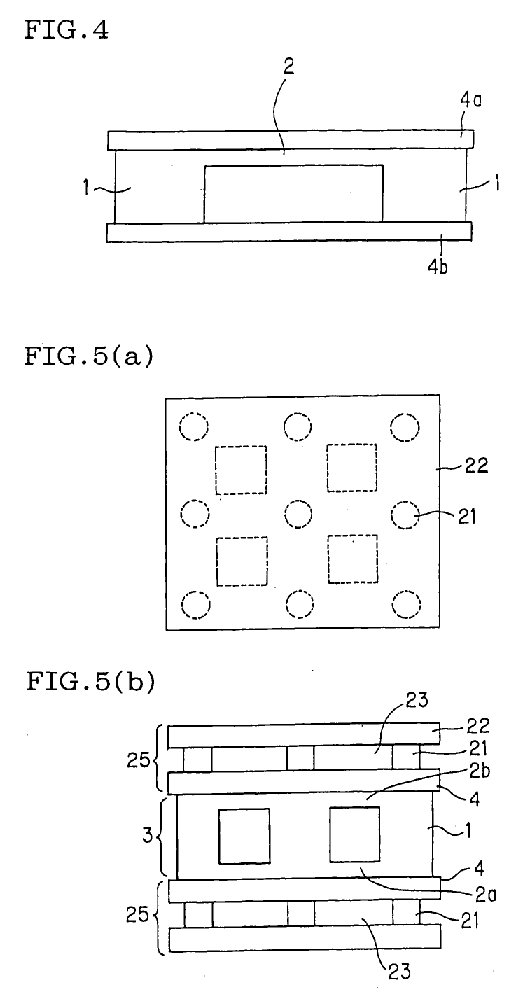

Furthermore, as shown in FIG. 1, the thermal buffer 4 in the present invention is brought into contact with preferably the thin portion 2 including at least an outer surface F₁, further preferably the thin portion including an outer surface F₂ constituted by the thin portion 2 and the thick portion 1, because the heat can be uniformly transferred to the thin portion 2 at a firing time, and firing unevenness of the formed body 3 can be suppressed. To reduce the deflection of the thin portion of the formed body at the firing time and further suppress the deformation of the whole formed body, as shown in FIG. 4, thermal buffers having flat plate shapes are preferably used, at least one of the thermal buffer 4a, 4b is preferably brought into contact with the thin portion 2, and the two thermal buffers 4a, 4b are most preferably disposed in positions facing each other across the formed body 3.

Moreover, the firing is preferably performed in a state in which the formed body is pressurized by the thermal buffer in that warp or undulation of the whole ceramic body can be suppressed. A pressurizing method is not especially limited. For example, as shown in FIG. 1 and the like, it is preferable that the formed body is disposed in such a manner that the upper surface of the thin portion 2 is substantially horizontal, and the thermal buffer is disposed on the upper surface of the thin portion 2 to pressurize the formed body. Here, a substantially horizontal state means a horizontal degree such that the thermal buffer disposed on the upper surface of the thin portion does not naturally fall. The upper surface of the thin portion is preferably horizontal to such an extent that the upper surface of the thin portion has an angle of 5° or less with respect to a horizontal face.

Moreover, as shown in FIG. 3, in a case where the formed body has a diaphragm structure including two thin portions 2a, 2b facing each other across the hollow portion 8, it is preferable that the formed body is disposed in such a manner that the surfaces of two thin portions are horizontal, and two thermal buffer 4a, 4b are preferably arranged in such a manner that the whole formed body is vertically held.

Accordingly, the difference of the sintering completion time can be reduced between the thin portions 2a, 2b and the thick portion 1, further between two thin portions 2a and 2b, and the deflection of the thin portion at the firing time can be reduced. When the formed body 3 is held between two thermal buffers 4a, 4b by the whole upper/lower surface of the formed body, in addition to the reduction of the deflection in the thin portion, deformation such as warp and undulation of the whole formed body can be suppressed. It is to be noted that even when the thin portion does not contact with the thermal buffer, pressure is uniformly applied to a directly contacting convex portion, and accordingly deformation such as warp and undulation of the whole formed body can be suppressed.

When a pressurizing force in pressurizing the formed body is excessively small, a sufficient effect is not obtained, and warp and the like may occur. When the force is excessively large, firing shrinkage in a plane direction is influenced, dimensional strain of the plane direction may occur, and the formed body may break. An appropriate weighting amount relates to a volume of the formed body, and is preferably 1×10⁻⁴ to 2×10⁻¹ g/mm³ (per unit volume of the formed body), further preferably 2×10⁻⁴ to 1×10 ⁻¹ g/mm³, especially preferably 1×10 ⁻³ to 1×10⁻¹ g/mm³.

In the present invention, the thermal buffer 4 shown in FIG. 1 and the like is preferably capable of releasing gas to the outside which is generated by burning of organic components in the formed body during firing to inhibit the ceramic body from breakage by accumulation of the gas. Concretely, a thermal buffer constituted of a porous body is preferably used. A buffer constituted of a porous body having a porosity of 1 to 70% is preferable, and the buffer constituted of a porous body having a porosity of 1 to 50%, especially 1 to 25% is further preferable. In a similar respect, the thermal buffer 4 having a thickness of 0.3 to 10.0 mm is preferable, and a thickness of 0.5 to 5.0 mm is further preferable.

Moreover, the pressure by the thermal buffer 4 may not only be adjusted by the thickening of the thermal buffer, but also preferably be adjusted by a firing jig 25 as shown in FIGS. 5(a), 5(b). The firing jig comprises; a thermal buffer portion (thermal buffer 4) formed of porous ceramic; a spacer 21 disposed on the surface of the buffer portion; and a weight adjusting portion (or a weight adjusting member 22) disposed in non-contact state with respect to the thermal buffer portion (or the thermal buffer 4). In the jig, a space 23 is formed between the thermal buffer portion (or the thermal buffer 4) and the weight adjusting portion (or the weight adjusting member 22). The firing jig 25 is preferably disposed on at least the upper surface of the formed body.

When the firing jig 25 is disposed on the upper surface of the formed body, the thickness or the like of the weight adjusting portion (or the weight adjusting member 22) can be changed to thereby adjust the weighting with respect to the formed body 3. Moreover, gas generated from the thin portions 2a, 2b during firing is securely released via the space 23 existing between the thermal buffer portion (or the thermal buffer 4) and the weight adjusting portion (or the weight adjusting member 22). The positions of the spacers 21 are not especially limited. However, to reduce the influence of the change of the heat capacity per unit area by the arrangement of the spacers, as shown in FIGS. 5(a), (b), the spacer is disposed preferably on the thick portion, further preferably in a position distant from the thin portion. When there are a plurality of thin portions, the spacers are preferably arranged at substantially equal distances from the thin portions.

It is to be noted that when the firing jig 25 is used, the dimension of the thermal buffer portion (or the thermal buffer 4) does not have to be limited from a viewpoint of the weighting with respect to the formed body 3. Therefore, while adjusting the thickness or the like of the weight adjusting portion (or the weight adjusting member 22), the thermal buffer portion (or the thermal buffer 4) is thinned or the porosity is raised. Accordingly, desired weighting with respect to the formed body is secured, and the gas generated from the thin portion 2 at the firing time can be more securely released to the outside. The firing jig 25 is also useful for the thin portion 2a positioned below the formed body 3. In this case, the thin portion 2 of the formed body 3 does not directly contact with a base of a setter or the like, and a release route of the gas generated from the thin portion 2 at the firing time is secured by the space 23. In this case, since the weight adjusting portion (or the weight adjusting member 22) does not have a function of adjusting the weighting, the effect of the jig can be obtained by the thermal buffer portion (or the thermal buffer 4) and the spacers. Furthermore, the firing jig 25 has a similar effect not only in the manufacturing method of the present invention but also in the firing to form a sheet-like ceramic body, a laminated sheet-like ceramic body, or a ceramic body having another shape. Here, the thermal buffer portion (or the thermal buffer 4) is preferably porous body having a porosity of preferably 1 to 70%, further preferably 1 to 50%, especially preferably 1 to 25%. The thickness is preferably 0.3 to 10 mm, more preferably 0.5 to 5 mm.

Moreover, the spacer is preferably positioned above the formed body or the ceramic body from the start of the firing till the end thereof. When the thin portion is a large plate, load is uniformly applied to periphery and central portion of a plate, accordingly the deformation of the thin portion can be suppressed, and the formed body can be securely pressurized. Even when the thin portion is not brought into contact with the thermal buffer portion, the weight is uniformly applied to the directly contacting convex portion, and accordingly the deformation of the formed body including the thin portion can be suppressed. Even when the spacer is arranged above the formed body, and the weight adjusting portion sufficiently pressurizes the formed body, but when the spacers shift from positions above the formed body, or the ceramic body obtained from the formed body by shrinkage, a pressurized state changes during the sintering, and smooth shrinkage is sometimes inhibited. As shown in FIGS. 5(a), (b), when the spacers exist constantly vertically above the formed body or the ceramic body, a ceramic body having a satisfactory dimensional precision can be obtained.

In the present invention, with regard to the thermal buffer 4 shown in FIG. 1 and the like, in a case where at least a part of the formed body 3 is brought into direct contact with the thermal buffer 4, frictional resistance between the formed body 3 and the thermal buffer 4 is preferably reduced to have uniform firing shrinkage. For this purpose, the arithmetic average roughness (Ra75) of a contact face of the thermal buffer with the formed body 3, preferably the whole surface of the thermal buffer is preferably 0.1≦Ra75≦10.0 μm, further preferably 0.1≦Ra75≦6.0 μm, especially preferably 0.1≦Ra75≦3.0 μm. It is to be noted that in the firing jig of the present invention, the thermal buffer portion, the weight adjusting portion, and the spacer may be a single piece, or may be disassemblable.

In the present invention, the formed body 3 comprising the diaphragm structure may be prepared, for example, by a doctor blade process, a reverse roll coater process, a calendar roll process, a casting process, a hot press process, an injection forming process, an extrusion forming process and the like. Above all, the formed body prepared by the doctor blade process is preferable because the formed body has a satisfactory precision, and comprises the thin portion 2 having a small thickness.

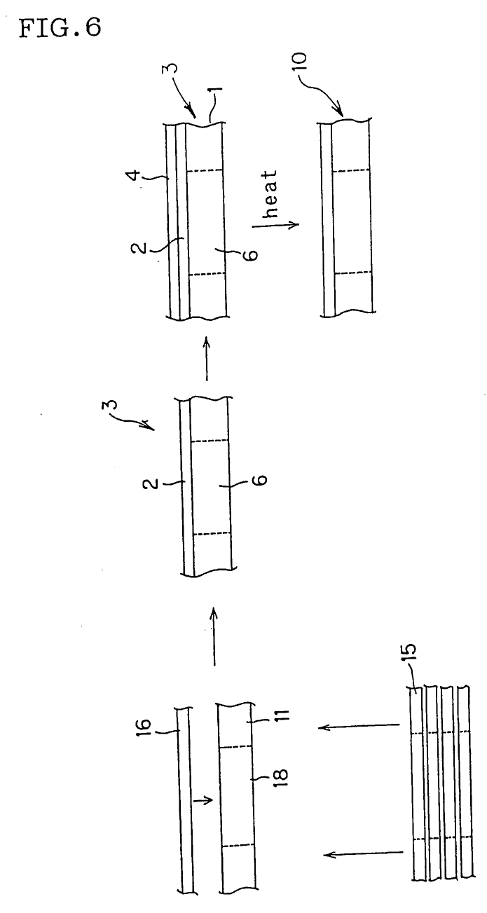

Moreover, when the formed body formed by a sheet forming method such as a doctor blade process is used, as shown in FIGS. 6 and 8, green sheets 15 obtained by the respective forming processes are cut, punched, and worked otherwise, and accordingly at least one or more through holes 18 having a size corresponding to that of a final concave portion 6 or hollow portion 8 is/are formed. Thereafter, the sheets are laminated to thereby prepare a laminated body 11, and a green sheet 16 constituting the thin portion 2 is laminated at least one of upper and lower surfaces of the laminated body 11 in which the through hole 18 are open. Accordingly, it is possible to obtain the formed body 3 having the diaphragm structure in which the plate-like thin portion 2 is supported between the thick portions 1, and the concave portion 6 or the hollow portion 8 is formed under or on the thin portion 2. It is to be noted that a formed body having only one concave portion or hollow portion may be prepared by a similar method, or a formed body having a plurality of concave portions or hollow portions may be prepared as shown in FIG. 8. As to the formed body having a plurality of concave portions or hollow portions, the formed body may have concave portions or hollow portions having different shapes. That is, the present invention is applicable to the firing of the formed body having only one diaphragm structure, and is also applicable to the firing of the formed body having a plurality of the same or different diaphragm structures. Moreover, when the formed body having a plurality of diaphragm structures is fired, the body can be divided into a plurality of fired bodies later. It is to be noted that when the formed body having a plurality of concave portions or hollow portions is prepared as shown in FIG. 8, a thin film layer may be formed as the convex portion with respect to a part or all of the thick portion of the formed body, and the thermal buffer may be disposed in such a manner as to cover the thin portion in a non-contact state with respect to the thin portion. The convex portion is preferably disposed around an outer periphery of the formed body.

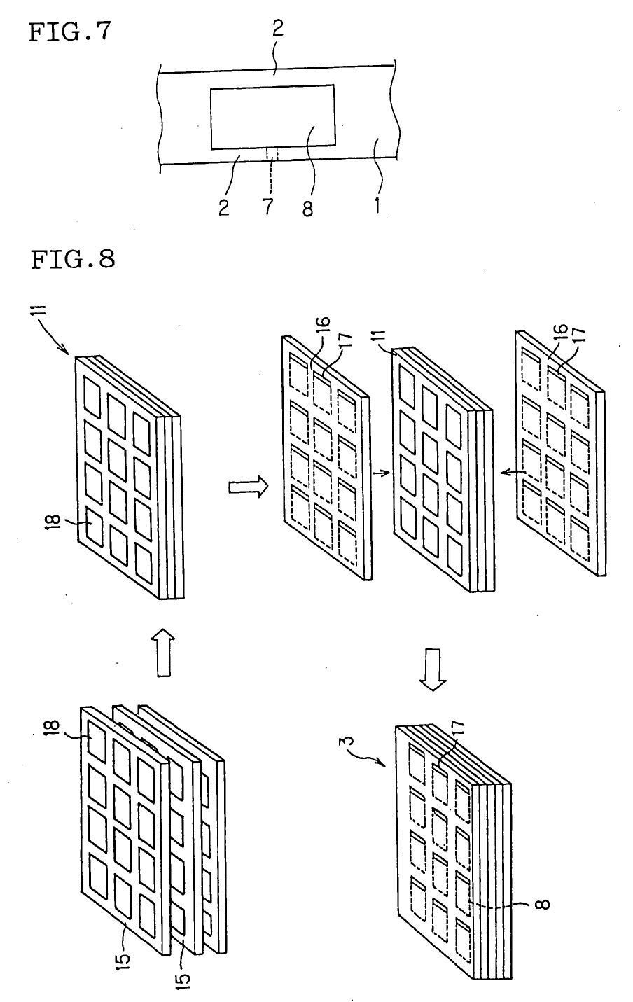

Needless to say, as shown in FIG. 7, to constitute a diaphragm structure (including a structure in which at least one of the thin portions 2 has a small-diameter communication hole 7 communicating with the hollow portion and the outside as shown in FIG. 7) in which two thin portions 2 facing each other across the hollow portion 8 are supported between the thick portions 1, as shown in FIG. 8, the laminated body 11 may be prepared in the same manner as described above. Thereafter, two green sheet 16 for constituting the thin portion 2 may be laminated on the upper and lower surfaces of the laminated body 11 in which the through hole 18 opens. In the embodiment shown in FIG. 8, to prevent the hollow portion 8 from being formed into a sealed space, a slit 17 communicating with the hollow portion 8 is preferably formed in each portion of the green sheet 16 constituting the thin-portion. This slit 17 is preferably formed in such a manner as to communicate with an end portion of the hollow portion. That is, the slit 17 is preferably formed in the green sheet 16 along a position corresponding to one of four sides of the laminated body 11 surrounding the through hole 18. It is to be noted that dotted lines in the green sheet 16 shown in FIG. 8 show positions of the through holes 18 of the laminated body 11.

In the present invention, a raw material of the formed body 3 is not especially limited. Examples of the raw material include a ceramic material mainly composed of at least one selected from a group consisting of stabilized zirconium oxide, partially stabilized zirconium oxide, aluminum oxide, aluminum nitride, magnesium oxide, titanium oxide, spinel, mullite, aluminum nitride, silicon nitride, cordierite forming raw material, silicon nitride, silicon carbide, and glass.

Moreover, in the present invention, the raw material of the formed body 3 may contain, addition to the ceramic materials, various additives if necessary. Examples of the additive include binder, dispersant, plasticizer, pore forming agent, sintering aid and the like.

The examples of the binder include hydroxypropyl methyl cellulose, methyl cellulose, ethyl cellulose, hydroxyethyl cellulose, carboxylmethyl cellulose, polyvinyl butyral, polyvinyl alcohol and the like. The examples of the dispersant include sorbitan fatty acid ester, ethylene glycol, dextrin, fatty acid soap, polyalcohol and the like. The examples of the plasticizer include di-2-ethylhexyl phthalate. The examples of the sintering aid include alumina (Al₂O₃), yttria (Y₂O₃), calcia (CaO), magnesia (MgO), ceria (CeO) and the like. It is to be noted that one type alone or a combination of two or more types of the additives may be used in accordance with a purpose.

Moreover, when a raw material containing a dispersion medium such as slurry is used, for example, a dispersion medium such as water; a hydrocarbon-based liquid compound such as petroleum; and alcohol may be added to the ceramic material.

In the present invention, as a firing temperature of a formed body 10, an appropriate temperature may be selected in accordance with the material of the formed body 10. For example, when the formed body 10 contains partially stabilized zirconium oxide as a main component, the temperature is preferably 1350 to 1550° C., more preferably 1400 to 1450° C.

Moreover, in the present invention, if necessary, the fired ceramic body is cut by dicing, wire cutting or the like, and can be, needless to say, formed into a desired shape.

As described above in detail, according to the present invention, even in a ceramic body of so-called diaphragm structure, there can be hardly deformation of the thin portion. Especially in a structure in which two thin portions facing each other across the hollow portion are supported between the thick portions, a ceramic body keeping symmetric shape can be obtained.

Moreover, since a ceramic body can be obtained by one firing step without undulation or warp, large reduction of energy consumption or product cost can be realized. Additionally, since a reforming step with respect to once deformed ceramic body is not required, there can be little remaining stress in the obtained ceramic body. Furthermore, there can be little grain growth of the ceramic material by re-heating. Therefore, durability of the obtained ceramic body can be largely enhanced.

The present invention will be described hereinafter further concretely in accordance with examples, but the present invention is not limited to these examples.

(Measurement method of arithmetic average roughness (Ra75))
(1) Measurement device: SURFCOM480A manufactured
by Tokyo Seimitsu Co., Ltd.

| | | |
|---|---|---|
| Probe | Tip radius: | 5 μm |
| | Tip angle: | 60° |
| | Material: | diamond |

(2) Measurement conditions

| | |
|---|---|
| Roughness measurement | |
| (conforming to JIS′82) | |
| Measurement speed: | 0.6 mm/sec |
| Cutoff: | 0.8 mm |
| Measurement distance: | 5 mm |

(Measurement Method of Deflection of Thin Portion)

The above-described device was used for ceramic bodies obtained in examples and comparative examples, and deflection of a thin portion was measured on the following conditions.

Sectional Shape Measurement
Measurement speed: 0.6 mm/sec

### EXAMPLE 1

First, after preparing a green sheet mainly composed of a zirconia forming raw material and having a thickness of 150 μm by a doctor blade process, six green sheets cut into each square shape having an outer dimension of 70×70 mm are obtained. In each of six green sheets, 100 square through holes (corresponding to hollow portions) in total, each having a size of 2.3×2.3 mm, were formed at an interval of 3 mm in ten rows and ten lines by punching. Subsequently, the green sheets having a plurality of square through holes are laminated via an adhesive mainly composed of the similar zirconia forming raw material.

Next, one green sheet mainly composed of the zirconia forming raw material and having a size of 70×70 mm and thickness of 60 μm was prepared by the doctor blade process. Next, the green sheet was laminated on the upper surface of a laminated body having a plurality of through holes prepared beforehand via an adhesive mainly composed of the zirconia forming raw material, and a formed body was formed (heat capacity difference per unit area between the thin and thick portions: 0.17 J/° C./cm², thermal conductivity after forming ceramic: 2.6 W/m K).

Next, a thermal buffer plate having a size of 75×75 mm and a thickness of 1 mm and formed of alumina (heat capacity per unit area: 0.36 J/° C./cm², thermal conductivity: 3.89 W/m K, porosity: 19%, surface roughness (Ra75): 1.0 μm) was brought into contact with the whole upper surface of the formed body (the whole surface constituted by the thin and thick portions).

Finally, in a state in which the thermal buffer plate was brought into contact with the thin portion, a weight adjusting member was disposed in an upper part of the plate via a spacer, and a formed body was fired at 1400° C. for two hours to thereby manufacture a ceramic body having a diaphragm structure. At this time, the weight applied by the thermal buffer plate, spacer, and weight adjusting member was 60 g.

### EXAMPLE 2

Green sheets mainly composed of a zirconia forming raw material and each having an outer shape of 70×70 mm and a thickness of 60 μm in a diaphragm structure in which a slit was disposed in a portion corresponding to one of four sides surrounding a hollow portion, that is, green sheets each having a shape corresponding to that of a green sheet 16 shown in FIG. 8 were laminated on upper and lower surfaces of a laminated body having through holes. A thermal buffer plate was brought into contact with a thin portion in such a manner as to hold upper and lower thin portions between two thermal buffer plates. Subsequently, a ceramic body having the diaphragm structure was manufactured in the same manner as in Example 1.

### COMPARATIVE EXAMPLE 1

A formed body was prepared in the same manner as in Example 1 except for firing the body at 1400° C. for two hours in a state in which the upper surface of the formed body was brought into direct contact with the atmosphere without using any thermal buffer plate. Thereafter, weight was applied under re-heating at 1350° C. for five hours, and accordingly warp and undulation of a whole sample were corrected.

### COMPARATIVE EXAMPLE 2

A formed body was prepared in the same manner as in Example 2. The body was fired at 1400° C. for two hours without using any thermal buffer plate. Thereafter, weight was applied under re-heating at 1350° C. for five hours, and accordingly warp and undulation of a whole sample were corrected. A ceramic body having a diaphragm structure was manufactured on other conditions that were the same as those of Example 2.

(Evaluation Result)

A distance from a straight line connecting opposite ends of a thin portion to a deepest point of deformation of a thin portion on a hollow portion side was regarded as deflection of the thin portion. Measurement results are shown in Table 2. As shown in Table 2, the deflection of the thin portion was 10.1 μm in Comparative Example 1, but 3.1 μm in Example 1. It has been proved that the present invention is effective in reducing the deflection. In the sample of Example 2, the deflection of the upper thin portion was 2.9 μm, and that of the lower thin portion was 2.0 μm. A ceramic body keeping satisfactory symmetry between the upper/lower thin portions was obtained. On the other hand, as to the sample of Comparative Example 2, the deflection of the upper thin portion was 9.8 μm, that of the lower thin portion was 4.0 μm, and a ceramic body was obtained whose symmetry of the upper/lower thin portions was impaired.

TABLE 2
Deflection of thin portion

| | | Line number | | | | | | | | | | |
|---|---|---|---|---|---|---|---|---|---|---|---|---|
| | | 1 | 2 | 3 | 4 | 5 | 6 | 7 | 8 | 9 | 10 | Average |
| Example 1 | | 2.9 | 3.1 | 3.2 | 3.1 | 3.3 | 3.4 | 3.1 | 2.9 | 3.0 | 2.8 | 3.1 |
| Example 2 | Upper | 2.8 | 2.9 | 2.8 | 2.9 | 3.1 | 3.1 | 2.9 | 2.8 | 2.8 | 2.8 | 2.9 |
| | Lower | 1.8 | 1.9 | 1.9 | 2.1 | 2.2 | 2.0 | 2.2 | 1.8 | 1.8 | 1.9 | 2.0 |
| Comparative | | 9.5 | 9.8 | 10.2 | 10.3 | 10.2 | 10.5 | 10.0 | 10.0 | 9.9 | 10.1 | 10.1 |
| Example 1 | | | | | | | | | | | | |
| Comparative | Upper | 9.7 | 9.8 | 9.6 | 9.9 | 10.0 | 10.0 | 9.9 | 9.8 | 9.9 | 9.8 | 9.8 |
| Example 2 | Lower | 3.9 | 4.0 | 3.8 | 4.1 | 4.1 | 4.1 | 4.2 | 4.1 | 4.0 | 4.0 | 4.0 |

Unit: μm

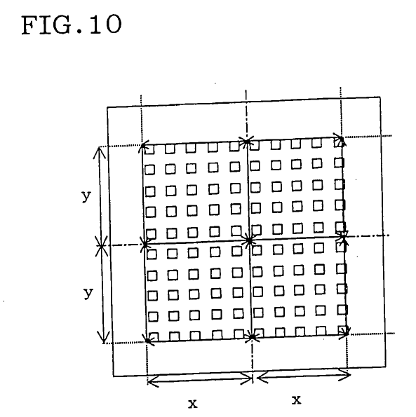

The whole samples of Examples 1 and 2 did not have any warp, and were equivalent to Comparative Examples 1 and 2 in this respect. A warp amount of a formed body defined by a height difference between highest and lowest portions of the outer surface of the thick portion was 15 μm or less, and indicated a satisfactory state. A dimension of a plane direction of each sample shown in FIG. 10 was also measured, and results are shown in Table 3. Dimensional precision of the samples of Examples 1 and 2 in the plane direction were not impaired, and high-precision samples equivalent to those of Comparative Examples 1 and 2 prepared in a conventional method were obtained.

TABLE 3

| | | | | | Comparative | | Comparative | |
|---|---|---|---|---|---|---|---|---|
| | Example 1 | | Example 2 | | Example 1 | | Example 2 | |
| | x | y | x | y | x | y | x | y |
| Distance | 19.920 | 19.922 | 19.923 | 19.923 | 19.921 | 19.923 | 19.924 | 19.922 |
| between | 19.921 | 19.920 | 19.921 | 19.920 | 19.920 | 19.923 | 19.922 | 19.919 |
| two points | 19.917 | 19.915 | 19.916 | 19.916 | 19.917 | 19.920 | 19.920 | 19.915 |
| | 19.915 | 19.916 | 19.918 | 19.915 | 19.914 | 19.916 | 19.916 | 19.917 |
| | 19.919 | 19.919 | 19.917 | 19.916 | 19.918 | 19.917 | 19.919 | 19.917 |
| | 19.924 | 19.921 | 19.920 | 19.920 | 19.920 | 19.920 | 19.921 | 19.921 |
| Average | 19.919 | 19.919 | 19.919 | 19.918 | 19.918 | 19.920 | 19.920 | 19.919 |
| Maximum value − | 0.009 | 0.007 | 0.007 | 0.008 | 0.007 | 0.007 | 0.008 | 0.007 |
| minimum value | | | | | | | | |

Unit: mm

Furthermore, as to the samples of Examples 1 and 2, the re-heating after the firing was not required, and mechanically superior samples were obtained. Needless to say, costs and time were saved.

As described above, the manufacturing method of the present invention can be preferably applied to the manufacturing of the ceramic body having the diaphragm structure applied to a piezoelectric/electrostrictive film type device or the like. The jig of the present invention is preferably usable in manufacturing the ceramic body.

1. A method of manufacturing a ceramic body comprising a step of firing a formed body having a diaphragm structure including a thick portion and thin portion disposed in such a manner that a concave portion or a hollow portion is formed by the thin and thick portions, wherein the firing is started in a state in which a thermal buffer is disposed in a position covering the thin portion in a contact or non-contact state with respect to the thin portion of the formed body.

2. The method of manufacturing the ceramic body according to claim 1, wherein the firing is started in a state in which at least two buffers having a flat plate shape are disposed as the thermal buffers in positions facing each other across the formed body.

3. The method of manufacturing the ceramic body according to claim 1, wherein the formed body has the diaphragm structure comprising the two thin portions disposed facing each other across the hollow portion, and the firing is started in a state in which the thermal buffers are disposed in positions covering two thin portions.

4. The method of manufacturing the ceramic body according to claim 1, wherein the thermal buffer having a heat capacity per unit area of equal to or higher than that of the thin portion covered with the thermal buffer is used.

5. The method of manufacturing the ceramic body according to claim 1, wherein a relation of a heat capacity difference (Cₛ) per unit area between the thin and thick portions with respect to a heat capacity (C_{b}) per unit area of the thermal buffer satisfies the following formula.
0≦((C_{b}−Cₛ)/Cₛ)×100≦300 1

6. The method of manufacturing the ceramic body according to claim 1, wherein an interval between the thin portion and the thermal buffer is not more than thickness of the thermal buffer, and not more than a thickness difference between the thick and thin portions.

7. The method of manufacturing the ceramic body according to claim 1, wherein the formed body having a convex portion formed on the surface thereof or the thermal buffer having a convex portion formed on the surface thereof is used to dispose the thermal buffer in such a manner as to bring the convex portion into contact with the thermal buffer or the formed body so that at least a part of the thin portion is brought into a non-contact state with respect to the thermal buffer.

8. The method of manufacturing the ceramic body according to claim 1, wherein the thermal buffer is a porous body having a porosity of 1 to 70%.

9. The method of manufacturing the ceramic body according to claim 1, wherein the firing is started in a state in which the thermal buffer pressurizes the formed body.

10. The method of manufacturing the ceramic body according to claim 9, wherein the formed body is disposed in such a manner that the upper surface of the thin portion is substantially horizontal, and the thermal buffer is disposed on an upper surface of the thin portion.

11. The method of manufacturing the ceramic body according to claim 10, wherein the firing is started in a state in which a spacer is disposed on the thermal buffer, and a weight adjusting member is disposed above the thermal buffer via the spacer.

12. The method of manufacturing the ceramic body according to claim 11, wherein the spacer is positioned above the formed body or a ceramic body from start of the firing till end of the firing.

13. The method of manufacturing the ceramic body according to claim 9, wherein a pressurizing force is a weight per unit volume in a range of 1×10⁻⁴ to 2×10⁻¹ g/mm³.

14. The method of manufacturing the ceramic body according to claim 1, wherein a thermal buffer having a thickness of 0.3 to 10.0 mm is used.

15. The method of manufacturing the ceramic body according to claim 1, wherein an arithmetic average roughness (Ra75) per unit contact area of a portion of the thermal buffer brought into contact with the formed body is 0.1≦Ra75≦10.0 μm.

16. The method of manufacturing the ceramic body according to claim 1, wherein thermal conductivity of the thermal buffer is larger than that of the thin portion.

17. A firing jig comprising: a thermal buffer portion formed of porous ceramic; a spacer disposed on one surface of the thermal buffer portion; and a weight adjusting portion disposed in non-contact with respect to the thermal buffer portion via the spacer, wherein a space is formed between the thermal buffer portion and the weight adjusting portion.

18. The firing jig according to claim 17, wherein the thermal buffer portion is a porous body having a porosity of 1 to 70%.

19. The firing jig according to claim 17, wherein the thermal buffer portion has a thickness of 0.3 to 10.0 mm.

20. The firing jig according to claim 17, wherein an arithmetic average roughness (Ra75) of at least a part of an outer surface of the thermal buffer portion is 0.1≦Ra75≦10.0 μm.
